(19) United States
(12) Patent Application Publication
(10) Pub. No.: US 2010/0115431 A1
(43) Pub. Date: May 6, 2010

(54) SYSTEM, PROCESS AND COMPUTER-ACCESSIBLE MEDIUM FOR ACCESSING AND NAVIGATING THE INTERNET

(75) Inventor: Bjorn Holte, Oslo (NO)

Correspondence Address: DORSEY & WHITNEY LLP;INTELLECTUAL PROPERTY DEPARTMENT, 250 PARK AVENUE, NEW YORK, NY, 10177, US

(73) Assignee: bMenu AS, Oslo (NO)

(21) Appl. No.: 12/606,944

(22) Filed: Oct. 27, 2009

Related U.S. Application Data
(60) Provisional application No. 61/108,810, filed on Oct. 27, 2008.

(51) Int. Cl. G06F 3/048

(52) U.S. Cl. 715/760; 715/854; 715/810; 715/811

(57) ABSTRACT

A computer-accessible medium, software arrangement and computer-system for providing access to a web page that is part of a web site is provided. According to an exemplary embodiment of the present application, provided is a computer-accessible medium having stored thereon executable instructions for providing access to a web page that is part of a web site. When the executable instructions are executed by a computer arrangement, the computer arrangement can be configured to perform the procedures including receiving and/or extracting information relating to a link structure of a web site and/or information relating to associated content; presenting the link structure and/or content in the form of a menu-based structure or a hierarchical structure having items that represent respective web pages; and, invoking a browser application and requesting an associated web page using the browser application, for example.

### CROSS-REFERENCE TO RELATED APPLICATIONS

This application claims priority from U.S. Patent Application Ser. No. 61/108,810 filed Oct. 27, 2008, and relates to U.S. Non-provisional application Ser. No. 11/364,393 filed Feb. 27, 2006 and Norwegian Appln. No. 20075435 filed Dec. 5, 2005, the entire disclosures of which are hereby incorporated herein by reference

### FIELD OF THE INVENTION

The exemplary embodiments of the present application relate to assessing and navigating the Internet. More specifically, a computer-accessible medium, software arrangement and computer-system for providing access to a web page that is part of a web site is provided.

### BACKGROUND OF THE INVENTION

Web browsers have generally become familiar tools for users wanting to access information, e.g, on the Internet, in intranets, and/or in databases with browser accessible user interfaces. Users can typically access information by first using a search engine to locate information which may be provided on large websites and/or to directly access information which may be present in databases. Results that can be provided by such search engines, e.g., in a results list or table, often may not indicate where in the archive the desired information is located. For example, there may often be several files or web pages having the same or similar content, which can make it difficult to determine which document or information may be the most correct or valuable for a specific search. Alternatively, users can access a welcome page of a desired web site, or a start page or portal for several web sites, and navigate their way through several web pages using links and menus found on the welcome page or portal until they find the desired information.

Various systems and methods have been provided to facilitate more readily accessible information. For example, system, method, and computer-accessible medium for navigating websites or databases using an arrangement of navigational drop-down menus is described, e.g., in U.S. patent application Ser. No. 11/364,393, the entire disclosure of which is hereby incorporated herein by reference in its entirety. Such navigational menus can be provided, for example, to facilitate access to specific web pages and/or specific content on web pages located within a web site, without loading or browsing intermediate or top-level pages in a hierarchy of the site. Such exemplary navigational menus can be, e.g., hierarchical, and may permit exploration of a particular topic or category, and can further provide direct access to certain information which may be located on various hierarchal levels within a web site, e.g., on a particular web page within a web site or at a certain location on such web page.

Further, Norwegian Patent Application No. 20075435, the entire disclosure of which is hereby incorporated herein by reference in its entirety, describes method and system for performing a search in a hierarchical information structure, such as navigational menus.

With such improvements, a user can still prefer to launch a web browser application, and access a relevant web page before a navigation menu for that particular web page can be opened.

Accordingly, there may be a need for even a more efficient way of accessing particular web pages directly, independent of the current status of or what operation is being performed by a user on a computer and independent of whether a web browser is already running on the user's computer.

### SUMMARY OF THE INVENTION

Exemplary embodiments of the present application can include, e.g., a computer-accessible medium, software arrangement and computer-system for providing access to a web page that is part of a web site.

According to certain exemplary embodiment of the present application, provided is a computer-accessible medium which can have stored thereon executable instructions for providing access to a web page that is part of a web site. For example, when the executable instructions are executed by a computer arrangement, the computer arrangement is configured to perform the procedures including receiving and/or extracting first information relating to a link structure of a web site and/or second information relating to content associated with the web site; presenting the link structure and/or the content in the form of a menu-based structure or a hierarchical structure having one or more items that represent one or more respective web pages. And, upon receipt of input from a user identifying a selected item from the one or more items, invoking a browser application and providing the selected item to the browser application as a parameter, and requesting, using the browser application, from the web site, a web page associated with the selected item, for example. According to an exemplary embodiment of the present application, the computer arrangement can be configured to perform the procedures including obtaining, from a browsing history list stored on a computer, third information associated with the web site and storing, on the computer, the third information in a list with one or more entries. And, for example, upon receipt of a request from a user, presenting the list in the form of a menu having one or more web sites, and, upon receipt of input from the user identifying a selection of the third information and transmitting to a server a request including the third information. A response from the server may include the first and/or second information.

According to an exemplary embodiment of the present application, the computer arrangement also can be configured to perform the procedures including requesting the first information or the second information directly from the web site when a response from the server does not include the first information. The first information or the second information also may be extracted from the browsing history, for example. The first information may be a XML file including information representative of at least part of a link structure of a web site, the second information may be, e.g., RSS or Atom, the third information may be a domain name, the content may be a news feed, and the one or more items may be, e.g., Universal Resource Locators or Universal Resource Indentifiers (“URIs”), for example.

According to an exemplary embodiment of the present application, provided is a software arrangement which is operable on a processor, the software arrangement including a computer program which, when executed, configures the processor to perform the procedures including receiving and/or extracting first information relating to a link structure of a web site and/or second information relating to content associated with the web site; presenting the link structure and/or the content in the form of a menu-based structure or a hierarchical structure having one or more items that represent one or more respective web pages. And, upon receipt of input from a user identifying a selected item from the one or more items, invoking a browser application and providing the selected item to the browser application as a parameter, and requesting, using the browser application, from the web site, a web page associated with the selected item, for example. According to an exemplary embodiment of the present application, the computer program may configure the processor to perform the procedures including obtaining, from a browsing history list stored on a computer, third information associated with a web site and storing, on the computer, the third information in a list with one or more entries. And, for example, upon receipt of a request from a user, presenting the list in the form of a menu having one or more web sites, and, upon receipt of input from the user identifying a selection of the third information, transmitting to a server a request including the third information. A response from the server may include the first and/or second information.

According to an exemplary embodiment of the present application, the computer program may configure the processor to also perform the procedures including requesting the first information and/or the second information directly from the web site when a response from the server does not include the first and/or second information. The first information and/or the second information also may be extracted from the browsing history, for example. The first information may be a XML file including information representative of at least part of a link structure of a web site, the second information may be, e.g., RSS or Atom, the third information may be a domain name, the content may be a news feed, and the one or more items may be, e.g., URIs, for example.

According to an exemplary embodiment of the present application, provided is a computer system including a computer configured to receive and/or extract first information relating to a link structure of a web site and/or second information relating to content associated with the web site; present the link structure and/or the content in the form of a menu-based structure or a hierarchical structure having one or more items that represent one or more respective web pages. And, for example, invoke a browser application and provide a selected item to the browser application as a parameter; and request, using the browser application, from the web site, a web page associated with the selected item. The computer may be configured to obtain, from a browsing history list stored on a computer, third information associated with a web site; store, on the computer, the third information in a list with one or more entries; present the list in the form of a menu having one or more web sites; and transmit to a server a request including the third information.

According to an exemplary embodiment of the present application, the computer may be configured to receive, from the server, a response including the first information and/or the second information, request the first information and/or the second information directly from the web site, and extract the first information and/or the second information from the browsing history. The first information may be a XML file including information representative of at least part of a link structure of a web site, the second information may be, e.g., RSS or Atom, the third information may be a domain name, the content may be a news feed, and the one or more items may be, e.g., URIs, for example.

These and other features and advantages of the present application will become apparent upon reading the following detailed description of embodiments of the invention, when taken in conjunction with the accompanying drawings and claims.

### BRIEF DESCRIPTION OF THE DRAWINGS

Further objects, features and advantages of the invention will become apparent from the following detailed description taken in conjunction with the accompanying Figures showing illustrative embodiments of the invention, in which:

FIG. 1 is an illustration of a system of computers communicating over a network which may be configured to operate in accordance with an exemplary embodiment of the present application;

FIG. 2 is an illustration of an exemplary architecture of a computer configured to implement an exemplary embodiment of the present application;

FIG. 3 is an exemplary screen shot illustrating a web start menu according to an exemplary embodiment of the present application; and

FIG. 4 is a flow chart illustrating generation and use of a web start menu in accordance with an exemplary embodiment of the present application.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF EXEMPLARY EMBODIMENTS

Exemplary embodiments of the present application can provide system, method and computer-accessible medium which can facilitate direct access to content in a web site or in a database without a prior search or a navigation through a plurality of introductory or intermediary content. The existence of and/or reference to the content can indicate at least a portion of a hierarchical structure of the web site or database, and further can display and/or otherwise indicate a location of a particular web page or other resource within the hierarchical structure.

According to certain exemplary embodiments of the present application, a method can be provided to facilitate a convenient access, e.g., from a computer to a particular web page that is part of a web site. The exemplary method can comprise (i) obtaining, from a browsing history list stored on a computer, information associated with said web site, (ii) storing, on the computer or a storage medium thereof or separately therefor, said information in a list of one or more entries, and, upon user request, (iii) presenting or providing the list as a menu of one or more web sites. Upon receipt of a user input identifying certain information obtained from a browsing history list stored on the computer, e.g., if the user hovers over a menu entry with a mouse pointer or other pointing graphical element, a request including such information can be transmitted to a server, for example.

The server can store information (e.g., on a storage medium thereof or separately therefor) representative of a link structure of one or more web sites, as described in above-referenced U.S. patent application Ser. No. 11/364,393, the entire disclosure of which is incorporated herein by reference in its entirety. For example, when the server receives a request identifying one such web site, a response including a description of the link structure can be transmitted to the requesting computer.

Upon receipt of a response from the server including first information relating to a link structure of the web site, the link structure can be presented in the form of at least one of a menu-based structure and/or a hierarchical structure comprising items representative of respective web pages. The link structure can, by way of example, be presented next to or near the list of web sites as an expansion of the web site that was selected, e.g., by a pointer controlled by a mouse or touch-pad hovering over it.

If a user selects one of the items representing web pages, e.g., by clicking on it with a mouse, the user input identifying this selection can be received, and in response, a browser application can be invoked. The invocation of the browser application can include providing the selected item to the browser as a parameter. The browser can then request the web page identified by the item from the associated web site.

According to various exemplary embodiments of the present application, the information obtained from a browsing history list stored on the computer can be, e.g., a domain name. The first information can be, e.g., an XML file including information representative of at least part of a link structure of a web site in the form of a number of Universal Resource Locators or Universal Resource Indentifiers (“URIs”) arranged in a hierarchical structure reflecting the organization of the web site, for example. The items described above can then be, e.g., URIs retrieved from this XML file and/or used as input to the browser application, which can request the web page, or, more generally, the resource identified by the URI as part of an HTTP request.

For example, not all possible web sites may be represented in a server, which can indicate that some responses from the server may not include the first information, e.g., the XML file representing a link structure. Thus, according to various exemplary embodiments of the present application, a similar request can be transmitted directly from a computer to an identified resource. If the first information is stored locally on, e.g., a web server of the identified web site, an XML file including this information can then be received directly from the web site, and the exemplary procedure can proceed as if the information were received from the server.

However, e.g., some web sites may not be represented in the server, and thus may not have any corresponding information stored locally at the web site. In this case, according to various exemplary embodiments of the invention, the exemplary procedure can proceed to request second information directly from the web site. This second information can relate to content, such as, e.g., a news feed, associated with the web site, for example. Upon the receipt of a response from the web site that includes the second information, e.g., information relating to a news feed associated with a web site, instead of presenting a link structure of the web site, the exemplary procedure can then proceed to present the content (e.g., news feed) in the form of a menu-based structure comprising items representative of respective web pages associated with, e.g., the news stories that are part of the news feed, for example. Upon the receipt of a user input identifying a selection of one of the items, such as, e.g., a mouse click, the exemplary procedure can again proceed by invoking a browser application, and providing the selected item to the browser as a parameter, and using the browser to request from the web site a web page represented by the item. The second information can be, e.g., an RSS feed or an Atom feed, and the items can be, e.g., URIs.

In some cases, no first information representing a file structure may be available from a dedicated server and/or a web site, and there may be no web content (e.g., news feed) associated with the web site, for example. In this case, e.g., all requests may receive negative responses. The exemplary procedure can then proceed by again consulting the browsing history from which the information representative of the web site obtained from the browsing history list stored on the computer was extracted. The exemplary procedure can then proceed by extracting a set of one or more items from the browsing history representing at least a subset of web pages previously visited at the web site. There must be at least one entry associated with the web site in the browsing history, since this is where the exemplary procedure obtained the reference to the web site.

Instead of presenting a link structure or content such as, e.g., news feed stories, the items representing previously visited web pages at that site can be presented in the form of a menu-based structure comprising items representative of the web pages, for example. Upon the receipt of user input, such as, e.g., a mouse click identifying a selection of one of the items, a browser application can be invoked and the item, e.g., an URI, can be provided to the browser as a parameter. The exemplary procedure can then proceed by using the browser to request from the web site a web page represented by the item.

According to another exemplary embodiment of the present application, a computer system can be configured with an application capable of performing the exemplary procedure according to an exemplary embodiment of the present application. This exemplary application can be presented, e.g., as part of the graphical user interface of the operating system (or a window manager system) of the computer in order to be readily available to a user at all times. The exemplary application can be associated with one or more configuration files, for example. The list of information items associated with a browsing history list stored on the computer, which can be, e.g., domain names, can be stored in such a configuration file. A configuration file can also include information specifying whether the list of web sites (e.g., domain names) can be dynamically updated based on user behavior (e.g., how often or how recently a site has been visited), and if so, whether certain sites should be locked such that they can not be removed from the list based on user behavior or preference, for example. A configuration file can also specify, e.g., how many sites the menu should include.

The exemplary computer system can be and/or include, e.g., a personal computer, a work station, a television, a set-top box or a smaller device such as a personal digital assistant (“PDA”), a mobile phone or other portable device with web browsing capabilities.

According to another exemplary embodiment of the present application, an article of manufacture is provided. The article of manufacture can comprise, e.g., a computer readable medium, which stores instructions thereon which, when executed by a computer, configure the computer to perform the exemplary procedure according to an exemplary embodiment of the present application as described herein, for example.

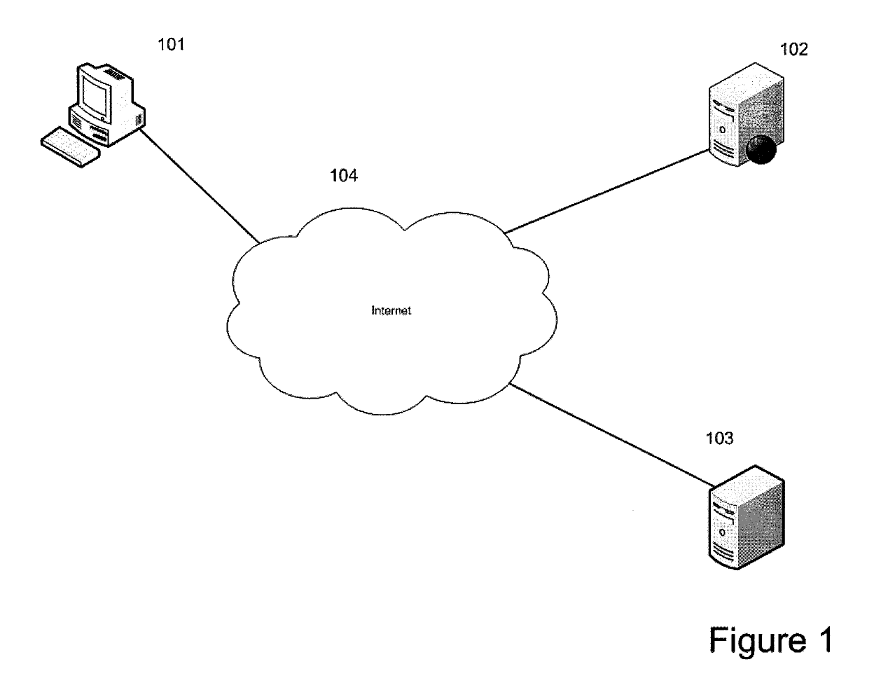

FIG. 1 illustrates an exemplary system upon which an exemplary embodiment of the present application can be implemented. For example, a user can utilize a computer 101, which can be, e.g., a personal computer and/or also include, e.g., the work station, television, set-top box or smaller device such as the PDA, mobile phone or other portable device with web browsing capabilities, to access content available from a web site residing on a web server 102. A representation of a link structure of the web site can be stored on a server 103. The computers or devices 101-103 (and others) can all be connected to the Internet 104 and/or another type of network over which they can exchange information.

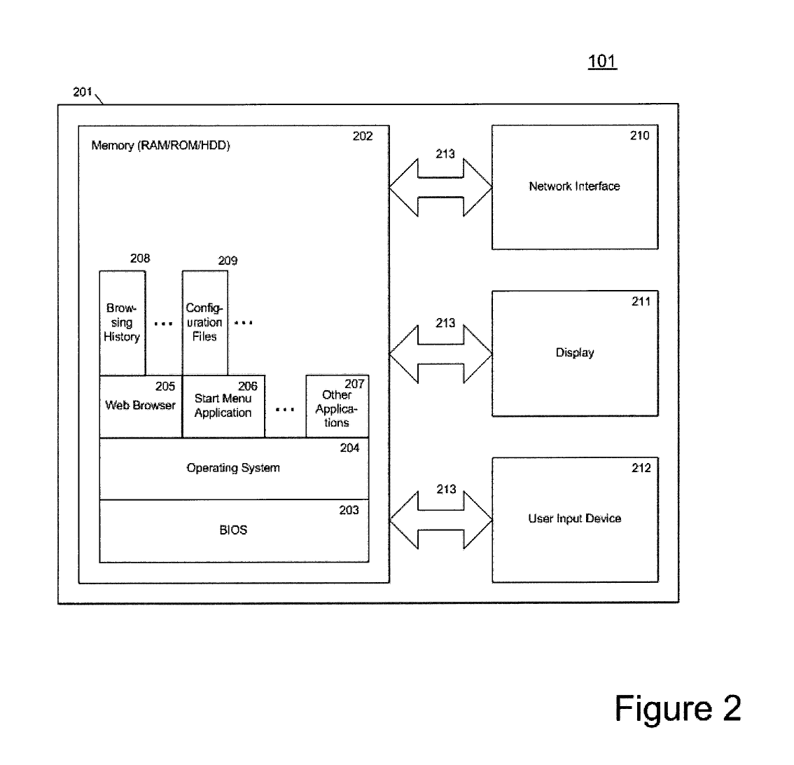

FIG. 2 Illustrates in a block diagram representing various modules and components that can be included in and/or used by the computer 101 configured to operate according to an exemplary embodiment of the present application. The computer 101 can include various hardware including, e.g., a motherboard 201 and other circuits/components for data processing, storing and/or facilitating data input and output. For example, FIG. 2 shows a system memory 202, which can include volatile and persistent memory circuits and other storage devices, including, e.g., RAM, ROM, hard disk drives, CD ROM stations, etc. The system memory 202 can include an input output system (BIOS) 203 for handling a basic startup of the system. The BIOS 203 can also handle communication between the system software and the various hardware components. An Operating System 204 can operate on a higher level and handle the management and coordination of activities and resources. The Operating System 204 can act as a host to certain application programs. Examples of operating systems such as the exemplary Operating System 204 can include, e.g., Microsoft®'s Windows®, Apple®'s Mac OS®, various versions of Linux® and UNIX®, etc.

Exemplary applications illustrated in the FIG. 2 can include, e.g., a web browser 205, a start menu application 206, which can be the application implementing many of the features of an exemplary embodiment of the present application, and/or other applications 207. The various applications can access or store data in data files. For example, web browsing history file 208 and start menu configuration file(s) 209 are shown as the exemplary embodiment in FIG. 2. The exemplary web browsing history file 205 can include a list of some or all files previously accessed by the web browser 205. When a web page is accessed by the web browser 205, the URI of the web page can be stored in the list along with the date and time when the page was last accessed, and/or a counter representing the number of times the page has been accessed, for example. Web pages can be accessed from web sites stored at remote web servers 102, and/or can also be accessed from servers located locally or even from on the same computer as the web browser 205, for example. Examples of the web browsers can include, e.g., Opera Software's OPERA, Mozilla's Firefox®, Microsoft®'s Internet Explorer®, etc.

The configuration file(s) 209 can read web sites present in a web start menu, along with other information relating to the operation of the web start menu application 206, for example.

In order for the web browser 205 to access remote web sites 102, a network interface 210 can be provided. Some or all communication between the various applications provided on the computer 101 and the resources located on the Internet 104 can be handled by the exemplary network interface 210. The exemplary computer system 101 can further include a display 211 and user input devices 212. The user input devices 212 can include, e.g., a keyboard, a mouse or a similar pointing device, or an input portion, including a part or the whole, of the display 211, which can be, e.g., a touch screen.

The various components of the exemplary computer system 101 can communicate over one or more system buses 213 and/or other interconnections such as cables, or over short range wireless (e.g., Bluetooth®), for example.

With respect to the server 103 illustrated in FIG. 1, reference is made to the above-referenced and herein incorporated U.S. patent application Ser. No. 11/364,393, which describes an example of how a link structure of a web site 102 can be extracted and a file representing such a link structure can be stored on a server such as exemplary server 103. A file associated with a web site can be identified by the domain name of the web site, and the link structure can be stored in an XML file containing a list of the URIs to which each link is pointing, for example. Alternatively, the web sites 102 can store their own XML files representing their own link structure.

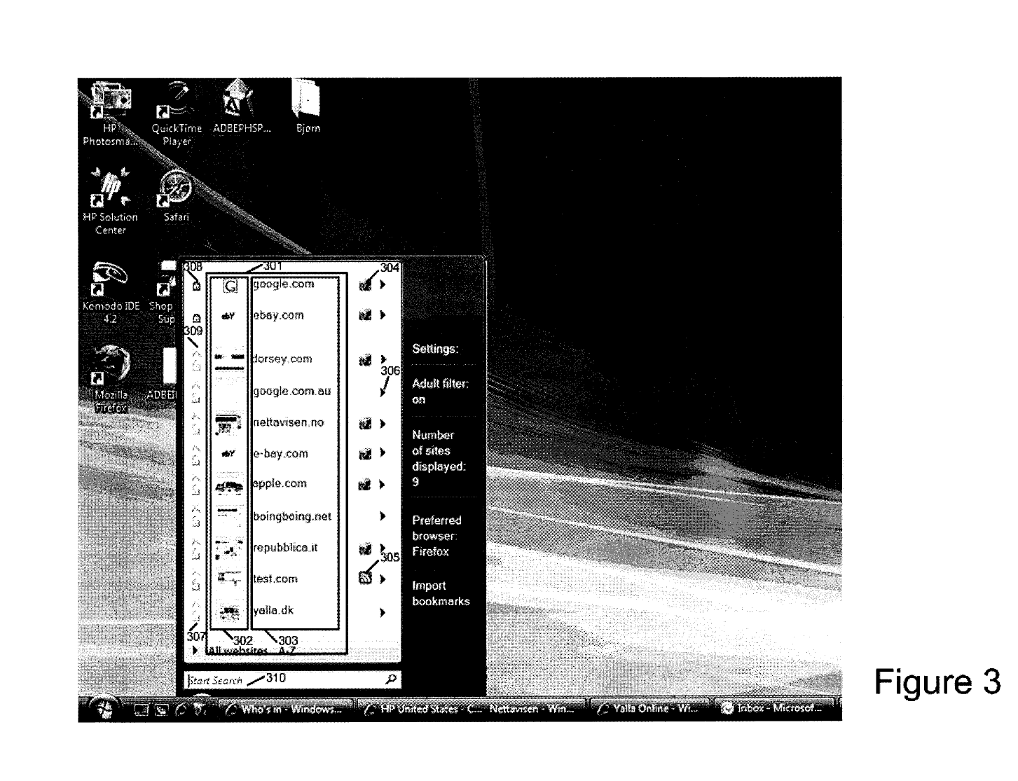

FIG. 3 illustrates an exemplary screenshot of a web start menu consistent with an exemplary embodiment of the present application. The illustrated example of FIG. 3 shows how a start menu can include a number of web sites 301 identified by an icon 302 and a domain name 303. Next to the identification of a web site there may be located an icon 304 indicating that a web menu is known to be available from a server 103, for example. There can be an icon 305 indicating that an RSS feed is available from the web site. In the example shown in FIG. 3, some of the entries likely do not have any icon 304 or 305 next to them. This can be web sites that do not have either navigation menus or content, such as, e.g., news feeds, associated with them, for example.

Next to the entries, triangles or arrows 306 can be provided indicating that if the entry is expanded, a sub-menu for that web site can be opened. According to some exemplary embodiments the additional menu can be opened if, e.g., a mouse pointer, or some other pointing device, hovers over the menu item. According to various exemplary embodiments of the present application, the menu can be expanded by, e.g., mouse clicks, double clicks or possibly with predefined keyboard strokes or voice commands.

According to various exemplary embodiments of the present application, such as illustrated in FIG. 3, for example, the opening page of the web site can be associated with the web site entry 301, and so the user is capable to indicate whether he or she wants to open that web page or to open a sub-menu associated within the web site. This could be achieved, for example, by two different forms of input, e.g., that hovering a pointer over the web page item results in opening the sub-menu, while clicking invokes the web browser and requests it to access the web site home page. Alternatively, one click could open the sub-menu while a double click can invoke the browser, for example. The same can also apply to entries in the sub-menus if they are hierarchical, for example.

An expansion of a sub-menu associated with a menu entry can result in a request for a navigation menu being sent to a server 103 or possibly to the web site itself, as described above. The presence of an icon 304 can indicate that the availability of such a navigation menu is already known. In some exemplary embodiments of the present application, a navigation menu that has previously been retrieved can be cached locally. Alternatively, a request can be sent to the web site every time a sub-menu is invoked, for example. If a navigation menu is available, whether it is because, e.g., it has already been cached on the local system or it is received in response to a new request, a number of entries (one or more) in the sub-menu can represent web pages on the web site. The web pages can be associated with additional menu entries in a lower level sub menu, which can be opened in the same manner as the sub-menu for the web site itself is opened, thus creating a hierarchical menu structure for the web site. The sub menu for a web page can be part of the hierarchical structure of the navigation menu XML file. Alternatively, the web page sub-menu can be stored in a separate XML file, for example. Although the web page sub menu can represent links that are present in the web page, the exemplary embodiments of the present application can include creating sub-menus that also include other links and/or sub menus that do not include any links that can be present on the actual web page.

If there is no navigation menu available for a particular web site, it can be, as described above, consistent with various exemplary embodiments of the present application to substitute, e.g., a news feed associated with the web site, if available. For example, if a news feed is known to exist, an icon indicating this may be present in the menu 305. If a news feed sub-menu is opened, the entries in this sub-menu can be headlines retrieved as part of a news feed request, e.g., an RSS feed. The entries will typically be associated with web pages identified by URIs, and clicking on a headline entry, for example, can invoke the user's preferred browser and request the identified web page. The web start menu application can be configured to display a predefined number of the most recent news headlines or base the number on user behavior, for example.

If neither a navigation menu nor content, such as, e.g., a news feed, is associated with the web site, opening a sub-menu can result in the opening of a list of previously visited pages associated with the web site. In this case, the web start menu application can be configured to select a predefined number of web pages from the preferred browser's history file based on a criteria such as most recently visited, most often visited or some other information. The criteria also can be, e.g., user defined and stored in a configuration file. Alternatively, this selection may have been done as part of the application design process and not be available for user configuration, for example.

The web start menu can be dynamically updated based on a user's behavior. However, the user interface may enable the user to prevent certain updates, for example, by locking a web site to the menu. According to the example illustrated in FIG. 3, this functionality may be accessed through lock icons 307. When a user clicks on a lock icon, the entry is marked in the configuration file as locked, and may not be removed even if the site is visited only rarely by the user. The top two entries in the menu of FIG. 3 are shown as locked through activated lock icons 308. List entry items can also represent sites that are listed by the server 103, that are always locked and that cannot be deleted by the user. Such web sites can, e.g., represent the provider of the server 103 or they can represent advertisers, for example.

Delete icons 309 may be provided to allow a user to remove menu entries from the menu. Clicking on such an icon can invoke instructions in the web menu application to delete the web site and any associated content such as a downloaded navigation menu, news feeds or icons or thumbnails, for example.

The icon representations of the web sites 302 can be icons downloaded from the web site, such as, e.g., favicons. According to some exemplary embodiments, if no favicon is available, a thumbnail representation of the web site itself can be generated. According to various exemplary embodiments of the present application, a thumbnail can be generated at the server 103, and the thumbnail or favicon can be received by the web menu application as part of the response to the request for a navigation menu. The server 103 also can be configured to generate and respond with a thumbnail or favicon even if no navigation menu is available. Alternatively, the web start menu application 206 can be configured to interact with the web browser application 205 to receive and store thumbnails and favicons, or to access them from a web browser cache memory, for example.

As illustrated in FIG. 3, the start menu 300 can include a search field 310. A search can be performed within site names, within menu items, or both, for example. A search can cover both locked sites, usage-based sites (e.g., frequent, recent), and listed sites. For example, a search can be executed after typing a number of characters, e.g. 1 to 5 characters, into the search field, and the initial search result can be displayed along with an option to do a site-search or global search. If the user types additional characters, the search can be re-evaluated and the displayed result set updated. In some exemplary embodiments of the present application, a search can only be performed when the user hits enter, clicks on a search button or in some other way initiates the execution of the search.

Search scopes can include, e.g., global searches, which can use the search provider selected in the Options dialogue, and site searches, which may only be valid if the menu has focus on a site (e.g., highlighted). The web site's built-in search functionality can be used if it is made available through the server 103, or one of the listed search providers can be used, for example.

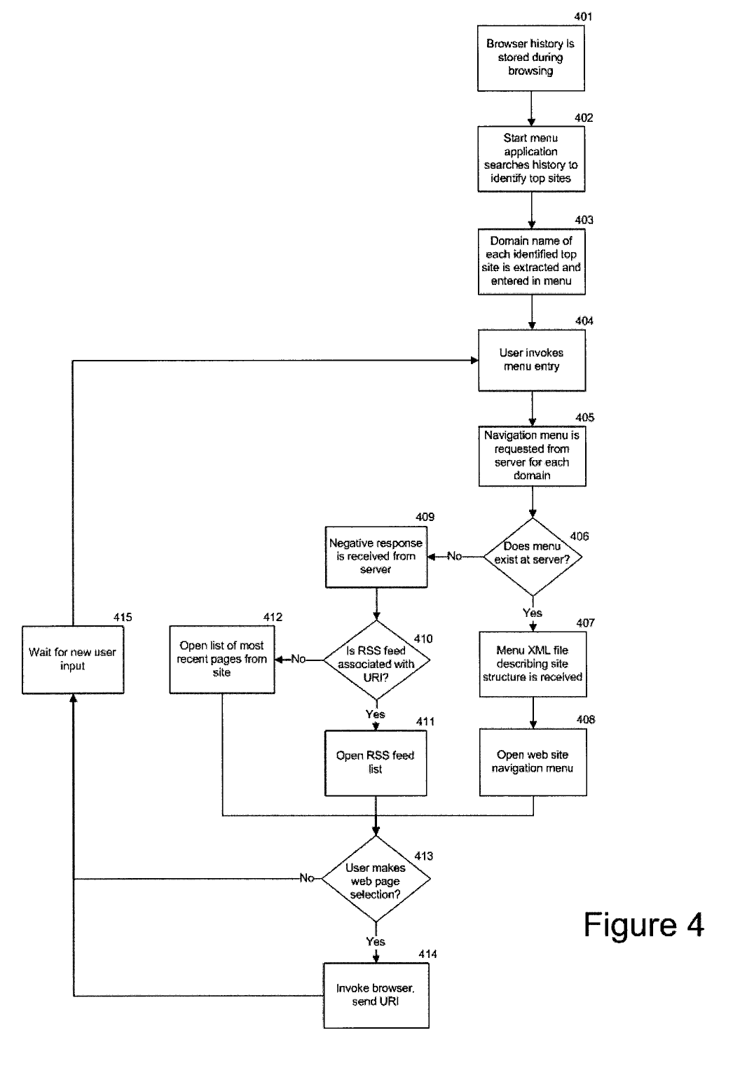

FIG. 4 shows a flow chart in which is illustrated how items can be added to a web start menu in accordance with an exemplary embodiment of the present application.

As shown in FIG. 4, in step 401, a browser history can be stored in a file during web browsing by the user. According to various exemplary embodiments of the present application, if there are multiple browsers installed on the computer 101, then only the browsing that is done with the browser that is associated with the web start menu application can be available for entry in the start menu.

In a next step 402, the exemplary start menu application can search or analyze the history file to identify web sites that should be entered in the start menu. This search can be, e.g., performed at regular intervals and/or when, e.g., the application is started and/or when the start menu is invoked by a user, depending on user configuration and/or design choices made while building the application, for example.

Web browsing can be done at any time and the browsing history file can consequently be updated at any time. Thus, in exemplary embodiments of the invention, it will be the browsing history file that is currently available on the computer 101 that is searched by the application.

As part of the search and analysis of the browsing history, the domain name of each identified top site can be extracted in step 403 and entered in a menu configuration file. The history list 208 can include the URI of several web pages from the same web site, which can be taken into consideration in order to identify the most popular sites, e.g., determining the total number of visited URIs for each domain.

Procedures of varying complexity for, e.g., combining the number of visits to web sites, frequency of visits and most recent visits, as well as other preferences, can be created and utilized for scoring and/or ranking web sites in order to determine which sites should be considered to be top web sites that should be entered in the start menu, for example.

After identifying the top web sites, the application can wait for a user to invoke a menu entry, e.g., by hovering a pointing device over the entry. When the user invokes a menu entry 404, the web start menu application can request a navigation menu from the server 103 in step 405. Such request can be sent as an HTTP GET request, for example.

Once the server 103 receives a request for a navigational menu, the next step, according to an exemplary embodiment of the invention illustrated in the FIG. 4, can be to determine whether a corresponding navigation menu is available (i.e., step 406). If a start menu is available, it can be transmitted to the computer 101, where it is received in step 407. The format of the menu can be, for example, an XML file archive format containing a set of items that each have, e.g., a site/menu title, URIs, graphical items such as thumbnails or favicons, and information on whether there is a further submenu. The retrieved information can be cached by the application for a predetermined or configurable length of time, e.g., ¼ to 3 hours or based on other criteria such as available memory or other system resources, user preferences and manufacturer settings, for example.

The exemplary received navigation menu can then be opened in step 408 and a navigation structure be displayed. This navigation structure can comprise a list of web pages that are a part of the web site, and which can be expanded into submenus if any submenus exist for such navigation menu entry. According to various exemplary embodiments of the present application, a submenu can be a part of the received navigation menu having a hierarchical structure. According to other exemplary embodiments of the present application, for example, sub menus can be requested in the same manner as the first navigation menu, in which case steps 404 through 408 can be repeated for the submenu if and when the user invokes a menu entry associated with a submenu.

The user can then make a selection in step 413, e.g. by clicking on a navigation menu entry or on a start menu entry identifying a site. If the user makes such a selection in step 413, then the web start menu application can invoke a browser in step 414, which can be a browser that is registered as a preferred browser according to a configuration of the exemplary application, or it can be the browser that is registered in the operating system 204 as a default browser, for example. The URI of the web page that has been selected by the user is passed to the browser, which can request that the web page from the web server 102, upon which the web page is stored, be loaded into the browser and displayed to the user.

The start menu application can then, in step 415, proceed to wait for new user input. When new user input is received in the form of an invocation of a menu entry the process, the exemplary procedure can return to step 404 and proceed as heretofore described accordingly.

If it is determined in step 406 that no navigation menu exists at the server, a response to that effect can be received from the server in step 409. According to various exemplary embodiments of the present application, the application can then proceed to request a navigation menu from the web server 102. If a navigation menu can be received from the web server 102, the exemplary procedure proceeds in the same manner as if it had been received from server 103. If, however, no navigation menu is available, the process can proceed to request from the web server 102 whether a news feed, such as, e.g., an RSS feed or an Atom feed, is available. If such a feed is available, a predetermined number of headlines can be requested from the web server 103, for example. When such requested headlines are received, the application can open a news feed list instead of a navigation menu, for example.

The entries in a news feed menu can be associated with, e.g., URIs, and if the user makes a selection by clicking on an entry, an exemplary procedure can proceed by invoking the browser in step 413 before it returns to wait for new user input.

If it is determined in step 410 that no news feed is associated with the web site, the exemplary procedure can proceed to step 412 and open a list of the most recently visited pages from that particular web site. For example, such a list can be generated by, e.g., again searching the history list of the preferred web browser, or it can already have been generated and cached during the initial search of the history list. Locally stored data associated with the browsing history can include information relating to a link structure of the web site and/or information relating to content associated with the web site. A user can make a selection of a web page included within the displayed list or hierarchy, in which case the browser can be invoked in step 413, as described above, for example.

The foregoing merely illustrates the principles of the invention. Various modifications and alterations to the described embodiments will be apparent to those skilled in the art in view of the teachings herein. For example, web pages, page content, page links, etc., can be provided on and/or accessed via an intranet instead of or in addition to via the Internet. It will thus be appreciated that those skilled in the art will be able to devise numerous systems, arrangements and methods which, although not explicitly shown or described herein, embody the principles of the present application and are thus within the spirit and scope of the present application. The detailed description, given by way of example, but not intended to limit the invention solely to the specific embodiments described, may best be understood in conjunction with the accompanying Figures. In addition, any patent, patent application and/or other publication cited herein is incorporated herein by reference in its entirety.

What is claimed is:

1. A computer-accessible medium having stored thereon executable instructions for providing access to a web page that is a part of a web site, wherein, when the executable instructions are executed by a computer arrangement, the computer arrangement is configured to perform the procedures comprising:
at least one of receiving or extracting at least one of first information relating to a link structure of a web site or second information relating to content associated with the web site;
presenting at least one of the link structure or the content in the form of at least one of a menu-based structure or a hierarchical structure having one or more items that represent one or more respective web pages;
upon receipt of input from the user identifying a selected item from the one or more items, invoking a browser application externally therefrom and providing the selected item to the browser application as a parameter; and
requesting, using the browser application, from the web site, a web page associated with the selected item.

2. The computer-accessible medium of claim 1, further comprising:
obtaining, from a browsing history list stored on the computer, third information associated with the web site;
storing, on the computer, the third information in a list with one or more entries;
upon receipt of a request from a user, presenting the list in the form of a menu having one or more web sites; and
upon receipt of input from the user identifying a selection of the third information, transmitting to a server a request including the third information.

3. The computer-accessible medium of claim 2, wherein a response to the request from the server includes at least one of the first information or the second information.

4. The computer-accessible medium of claim 2, further comprising:
requesting at least one of the first information or the second information directly from the web site, when a response from the server excludes at least one of the first information or the second information.

5. The computer-accessible medium of claim 2, wherein the third information is a domain name.

6. The computer-accessible medium of claim 1, wherein at least a portion of at least one of the first information or the second information is extracted from at least one of the browsing history or locally stored data associated with the browsing history.

7. The computer-accessible medium of claim 1, wherein the first information is a XML file including information representative of at least part of the link structure of the web site.

8. The computer-accessible medium of claim 1, wherein the second information is selected from the group consisting of RSS and Atom.

9. The computer-accessible medium of claim 1, wherein the content is a news feed.

10. The computer-accessible medium of claim 1, wherein the one or more items are URIs.

11. A software arrangement which is operable on a processor, the software arrangement comprising a computer program which, when executed, configures the processor to perform the procedures comprising:
at least one of receiving or extracting at least one of first information relating to a link structure of a web site or second information relating to content associated with the web site;
presenting at least one of the link structure or the content in the form of at least one of a menu-based structure or a hierarchical structure having one or more items that represent one or more respective web pages;
upon receipt of input from the user identifying a selected item from the one or more items, invoking a browser application and providing the selected item to the browser application as a parameter; and
requesting, using the browser application, from the web site, a web page associated with the selected item.

12. The software arrangement of claim 11, further comprising:
obtaining, from a browsing history list stored on the computer, third information associated with the web site;
storing, on the computer, the third information in a list with one or more entries;
upon receipt of a request from a user, presenting the list in the form of a menu having one or more web sites; and
upon receipt of input from the user identifying a selection of the third information, transmitting to a server a request including the third information.

13. The software arrangement of claim 12, wherein a response from the server includes at least one of the first information or the second information.

14. The software arrangement of claim 12, further comprising:
requesting at least one of the first information or the second information directly from the web site, wherein a response from the server does not include at least one of the first information or the second information.

15. The software arrangement of claim 12, wherein the third information is a domain name.

16. The software arrangement of claim 11, wherein the at least one of the first information or the second information is extracted from the browsing history.

17. The software arrangement of claim 11, wherein at least one of the first information is a XML file including information representative of at least part of a link structure of the web site, the second information is selected from the group consisting of RSS and Atom, the content is a news feed, or the one or more items are URIs.

18. A computer system, comprising:
a computer configured to:
at least one of receive or extract at least one of first information relating to a link structure of a web site or second information relating to content associated with the web site;
present at least one of the link structure or the content in the form of at least one of a menu-based structure or a hierarchical structure having one or more items that represent one or more respective web pages;
invoke a browser application and provide a selected item to the browser application as a parameter; and
request, using the browser application, from the web site, a web page associated with the selected item.

19. The computer system of claim 18, wherein the computer is configured to:
obtain, from a browsing history list stored on the computer, third information associated with the web site;
store, on the computer, the third information in a list with one or more entries;
present the list in the form of a menu having one or more web sites; and
transmit to a server a request including the third information.

20. The computer system of claim 19, wherein the computer is configured to receive from the server a response including at least one of the first information or the second information.

21. The computer system of claim 19, wherein the third information is a domain name.

22. The computer system of claim 18, wherein the computer is configured to request at least one of the first information or the second information directly from the web site.

23. The computer system of claim 18, wherein the computer is configured to extract at least one of the first information or the second information from the browsing history.

24. The computer system of claim 18, wherein at least one of the first information is a XML file including information representative of at least part of a link structure of the web site, the second information is selected from the group consisting of RSS and Atom, the content is a news feed, or the one or more items are URIs.
